(19) United States
(12) Patent Application Publication
(10) Pub. No.: US 2014/0112830 A1
(43) Pub. Date: Apr. 24, 2014

(54) Automated Analyzer

(71) Applicant: JEOL Ltd., Tokyo (JP)

(72) Inventor: Koichi Saika, Tokyo (JP)

(73) Assignee: JEOL Ltd., Tokyo (JP)

(21) Appl. No.: 14/059,663

(22) Filed: Oct. 22, 2013

(30) Foreign Application Priority Data
Oct. 22, 2012 (JP) 2012-232721

(51) Int. Cl. G01N 35/02

(52) U.S. Cl. CPC G01N 35/026
USPC 422/65

(57) ABSTRACT

An automated analyzer (100) has a second transport portion (40) including a first transport line (42) for conveying a second analyte holding container (4) located at a first position P1, a plurality of second transport lines (44a, 44b, 44c, 44d) for conveying second analyte holding containers (4) conveyed by the first transport line (42) into positions P10, P12, P14, P16, and a third transport line (46) for returning second analyte holding containers (4) to the first position P1. The control portion (72) performs a first processing step for associating identification information about first nonaliquoted analyte holding containers (2) with identification information about second aliquoted analyte holding containers (4) and a second processing step for sensing the positions of second analyte holding containers (4) and determining which of analyzing portions (60a, 60b, 60c, 60d) is used to analyze analytes.

### BACKGROUND OF THE INVENTION

1. Field of the Invention

The present invention relates to an automated analyzer.

2. Description of Related Art

Automated analyzers used for clinical examinations and capable of analyzing a sample such as a biological sample (e.g., blood serum, blood cells, urine, and bone marrow) have been known. Such an automated analyzer is required to have high processing capabilities, i.e., is capable of analyzing a large number of analytes in a short time.

For example, in the automated analyzer of JP-A-10-19899, in order to provide enhanced processing capabilities, information for identification of each analyte is read in the order in which analytes are introduced, and destinations of the analytes (i.e., to what analysis modules the analytes will be moved) are determined by a control unit according to information about request for analysis on each analyte and according to the circumstances of the analysis operation of each analytical work module.

### SUMMARY OF THE INVENTION

One object associated with some aspects of the present invention is to provide an automated analyzer which has a simple structure but can provide enhanced processing capabilities.

(1) An automated analyzer associated with the present invention has: a first transport portion for conveying a first analyte holding container that holds an analyte therein; a first identification portion for obtaining identification information about the first analyte holding container; an analyte delivery and receipt portion for picking up the analyte from the first analyte holding container and transferring the analyte to a plurality of second analyte holding containers; a second transport portion for conveying the second analyte holding containers; a second identification portion for obtaining identification information about the second analyte holding containers; a plurality of analyzing portions for picking up the analytes from the second analyte holding containers and analyzing the analytes picked up; and a control portion for controlling the second transport portion. The analyte delivery and receipt portion transfers the analytes into the second analyte holding containers at a first position. The second transport portion has a first transport line for conveying the second analyte holding container located at the first position, a plurality of second transport lines for conveying the second analyte holding containers conveyed by the first transport line into a pick-up position where the analyzing portions pick up the analytes, and a third transport line for returning the second analyte holding containers placed in the pick-up position into the first position. The control portion performs a first processing step for associating the identification information about the first analyte holding container with the identification information about the second analyte holding containers and a second processing step for sensing positions of the second analyte holding containers conveyed by the second transport portion based on the identification information about the second analyte holding containers and determining which of the analyzing portions is used to analyze the analytes.

In this automated analyzer, the control portion senses the positions of the second analyte holding containers conveyed by the second transport portion and determines which of the analyzing portions is used for analysis of the analytes. For example, according to the degrees of congestion of the analyzing portions, an analyzing portion to be used for analysis of the analytes can be determined. Accordingly, the processing capabilities can be enhanced.

Furthermore, in this automated analyzer, after analytes are picked up by the analyzing portions, the second analyte holding containers located in the first position can be returned to the first position by the first, second, and third transport lines. Therefore, one second identification portion can sense the positions of plural second analyte holding containers. Therefore, the analyzer has a simple structure but can have enhanced processing capabilities.

(2) In one feature of this automated analyzer, the control portion obtains information about the analyte held in the first analyte holding container, based on the identification information about the first analyte holding container. This automated analyzer has a simple structure but can have enhanced processing capabilities.

(3) In another feature of this automated analyzer, each of the analyzing portions may include a third identification portion for obtaining identification information about the second analyte holding container located at the pick-up position. In this automated analyzer, the analytes can be prevented from becoming mixed up.

(4) In a further feature of this automated analyzer, a transport path for the second analyte holding containers in the second transport portion may constitute a closed loop. This automated analyzer is simple in structure but can have enhanced processing capabilities.

(5) In an additional feature of this automated analyzer, the control portion may make a decision, based on the identification information about the second analyte holding containers, as to whether each of the analytes has been analyzed by the analyzing portion determined by the second processing step. In this automated analyzer, the analytes can be prevented from becoming mixed up.

(6) In a yet other feature of this automated analyzer, there may be further provided sensors used to make a decision as to whether each of the second analyte holding containers is in position. In this automated analyzer, the analytes can be prevented from becoming mixed up.

(7) In a still other feature of this automated analyzer, there may be further provided a cleaning portion for cleaning the second analyte holding containers passing through the third transport line. In this automated analyzer, the second analyte holding containers can be reused.

### BRIEF DESCRIPTION OF THE DRAWINGS

FIG. 1 is a schematic plan view of an automated analyzer associated with a first embodiment of the present invention, illustrating the configuration of the analyzer.

FIG. 2 is a schematic plan view of a part of a second transport portion included in the automated analyzer shown in FIG. 1.

FIG. 3 is a schematic plan view of another part of the second transport portion included in the automated analyzer shown in FIG. 1.

FIG. 4 is a schematic perspective view of first analyte holding containers.

FIG. 5 is a schematic perspective view of one of second analyte holding containers.

FIG. 6 is a flowchart illustrating a sequence of operations performed by the automated analyzer shown in FIG. 1.

FIG. 7 is a block diagram showing one set of flows of information through the automated analyzer shown in FIG. 1.

FIG. 8 is a flowchart illustrating a method of monitoring the second analyte holding containers.

FIG. 9 is a schematic plan view of an automated analyzer associated with a second embodiment of the present invention, illustrating the configuration of the analyzer.

FIG. 10 is a schematic plan view of a part of a second transport portion included in the automated analyzer shown in FIG. 9.

FIG. 11 is a flowchart illustrating a sequence of operations performed by the automated analyzer shown in FIG. 9.

### DESCRIPTION OF THE INVENTION

The preferred embodiments of the present invention are hereinafter described in detail. It is to be noted that the description described below do not unduly restrict the scope of the invention delineated by the appended claims and that not all the configurations set forth below are essential components of the invention.

### 1. First Embodiment

### 1.1. Configuration of Automated Analyzer

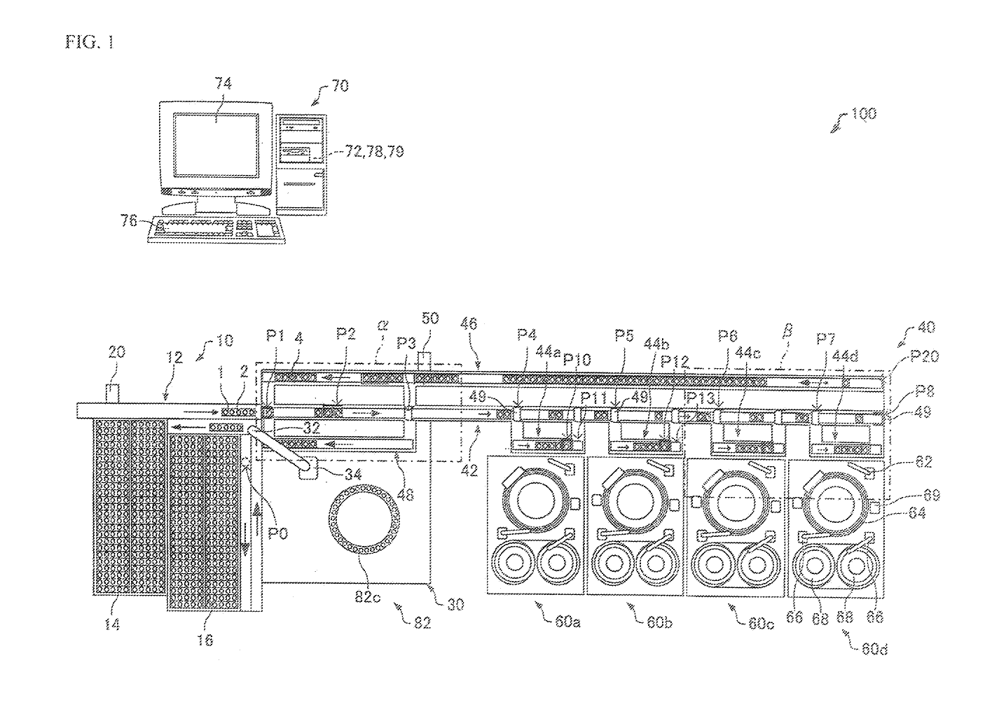

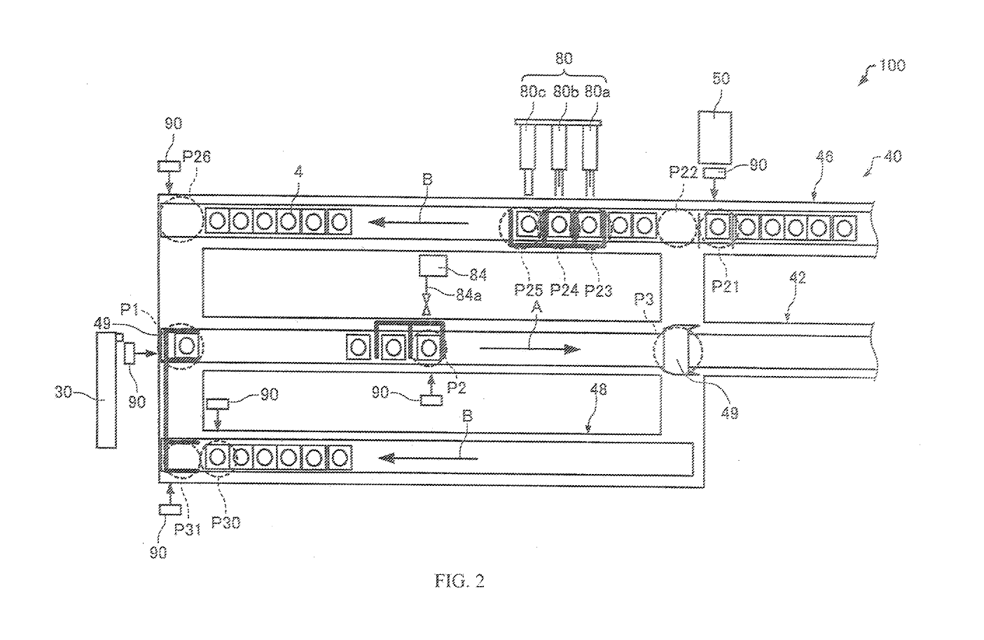

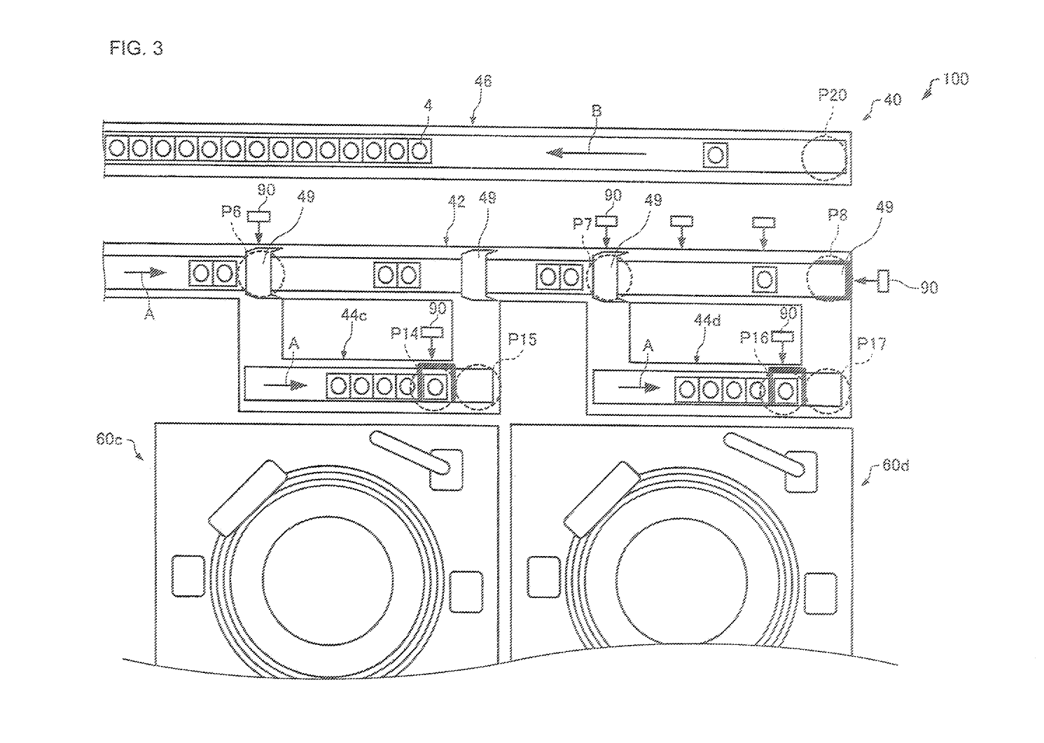

First, the configuration of an automated analyzer associated with a first embodiment of the present invention is described by referring to some drawings. FIG. 1 shows the configuration of the automated analyzer, generally indicated by reference numeral 100. FIGS. 2 and 3 schematically show parts of a second transport portion 40 included in the automated analyzer 100. FIG. 2 schematically shows a region α of FIG. 1. FIG. 3 schematically shows a region β of FIG. 1.

As shown in FIGS. 1-3, the automated analyzer 100 includes a first transport portion 10, a first identification portion 20, an analyte delivery and receipt portion 30, the second transport portion 40, a second identification portion 50, analyzing portions 60a, 60b, 60c, 60d, and a manipulation portion 70 that includes a control portion 72. Furthermore, the automated analyzer 100 can include a cleaning portion 80, an analyte diluting portion 82, a stirring portion 84, and sensors 90.

For example, the automated analyzer 100 is an apparatus used for clinical examinations and capable of analyzing analytes such as biological samples (e.g., blood serum, blood cells, urine, and bone marrow).

The first transport portion 10 can transport one or more first analyte holding containers 2 that accommodate non-aliquoted analytes. In the illustrated example, the first transport portion 10 conveys a rack 1 in which the first analyte holding containers 2 are held. The first transport portion 10 conveys each first analyte holding container 2 into a pick-up position P0 where an analyte is picked up. This position P0 is located over a transport line 12 of the first transport portion 10. The analyte delivery and receipt portion 30 picks up an analyte from the first analyte holding container 2 at the pick-up position P0.

In the illustrated example, the first transport portion 10 has the transport line 12 for transporting the first analyte holding containers 2, an analyte supply portion 14 on which the first analyte holding containers 2 having analytes therein are set, and a recovery portion 16 for recovering the first analyte holding containers 2 having the analytes picked up. The transport line 12 conveys the first analyte holding containers 2 having the analytes therein from the analyte supply portion 14 to the pick-up position P0. The transport line 12 conveys the first analyte holding containers 2, which has the analytes picked up at the pick-up position P0, from the pick-up position P0 to the recovery portion 16.

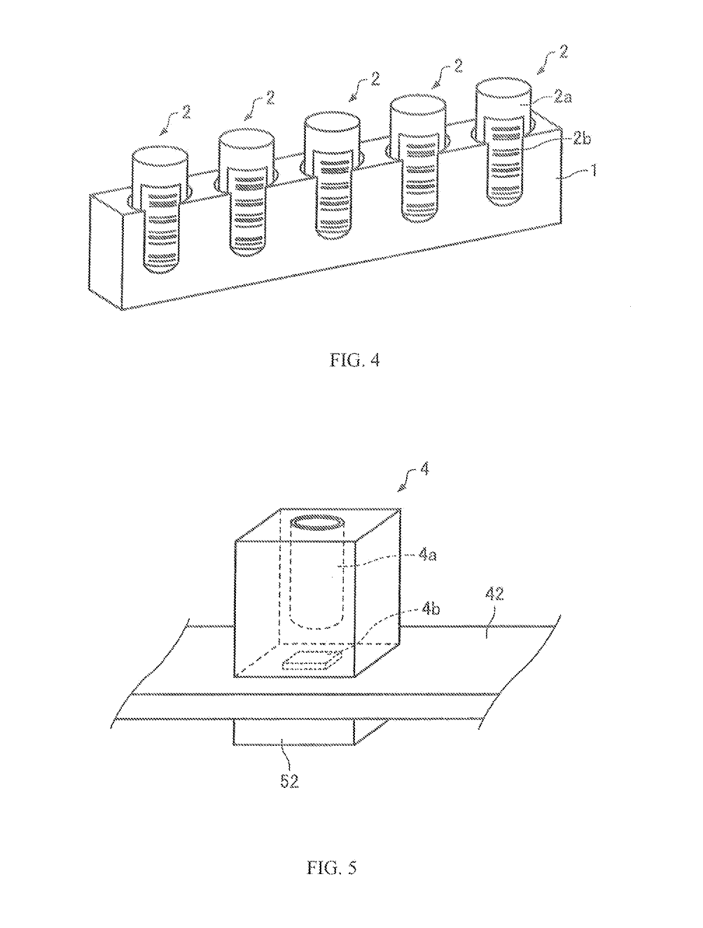

FIG. 4 is a schematic perspective view of the first analyte holding containers 2 which are accommodated in the rack 1. The first analyte holding containers 2 are containers for holding non-aliquoted analytes. Each first analyte holding container 2 is configured including a cell 2a for holding an analyte and a recording medium 2b which holds identification information about the first analyte holding container 2 and which can be read by the first identification portion 20. In the illustrated example, the recording medium 2b is a barcode attached to the cell 2a. The recording medium 2b is not restricted to a barcode. The recording medium may also be a magnetic recording medium or an IC tag such as an RFID (Radio-Frequency Identification) tag. In this embodiment, the identification information about each first analyte holding container 2 is information used to identify the subject first analyte holding container 2 from other first analyte holding containers 2. That is, identification data intrinsic to each first analyte holding container 2 is recorded on the recording medium 2b. In the automated analyzer 100, information about the analyte accommodated in each first analyte holding container 2 can be obtained based on the identification information about the container 2.

The rack 1 can hold one or more first analyte holding containers 2. In the illustrated example, the rack 1 holds five first analyte holding containers 2 but no restriction is placed on the number of held containers 2. The rack 1 is provided with a notch or notches permitting the recording medium 2b (barcode) to be read. The recording medium 2b that holds identification information about each first analyte holding container 2 may be attached to the rack 1 in an unillustrated manner. The case in which the first analyte holding containers 2 are held to the rack 1 has been described. Alternatively, the first analyte holding containers 2 are not held to the rack 1 but the first analyte holding containers 2 are directly placed on the transport line and transported.

The first identification portion 20 obtains identification information about each first analyte holding container 2 from the recording medium 2b of the first analyte holding container 2. The first identification portion 20 can read the identification information about each first analyte holding container 2. In the illustrated example, the first identification portion 20 reads the identification information about each first analyte holding container 2 between the analyte supply portion 14 and the pick-up position P0. For instance, the first identification portion 20 is a barcode reader for reading the recording medium (barcode) 2b on each first analyte holding container 2. Where the recording medium 2b is an IC tag, the first identification portion 20 may be an IC tag reader. The identification information about the first analyte holding container 2 obtained by the first identification portion 20 is sent to the manipulation portion 70.

The analyte delivery and receipt portion 30 picks up an analyte from each first analyte holding container 2 and moves the analyte into one second analyte holding container 4. The analyte delivery and receipt portion 30 picks up an analyte from the first analyte holding container 2 located at the pick-up position P0. The analyte delivery and receipt portion 30 dispenses the collected analyte into the second analyte holding container 4 located at a first position P1. Consequently, the non-aliquoted analyte received in the first analyte holding container 2 is aliquoted into the second detector holding containers 4. The first position P1 is on a first transport line 42 of the second transport portion 40. At this position, the analyte is moved into the second analyte holding containers 4 by the analyte delivery and receipt portion 30.

In the illustrated example, the analyte delivery and receipt portion 30 has a pipette 32 for aspirating and delivering analytes and a drive mechanism 34 for moving the pipette 32. The analyte delivery and receipt portion 30 aspirates an analyte from the first analyte holding container 2 located at the pick-up position P0 through the pipette 32. After the pipette 32 is moved into a position where the analyte can be dispensed into the second analyte holding container 4 located at the first position P1 by the drive mechanism 34, the pipette 32 dispenses the analyte into the second analyte holding container 4. The analyte delivery and receipt portion 30 may pick up an analyte together with the first analyte holding container 2 and move them into the second analyte holding container 4 in an unillustrated manner. That is, the second analyte holding container 4 is so formed, for example, as to be capable of accommodating the first analyte holding container 2. The analyte delivery and receipt portion 30 may transport the analyte into the second analyte holding container 4 along with the first analyte holding container 2.

The second transport portion 40 conveys plural second analyte holding container 4 each holding an aliquot of the analyte. The second transport portion 40 has the first transport line 42, a plurality of second transport lines 44a, 44b, 44c, and 44d, a third transport line 46, and a fourth transport line 48. Furthermore, the second transport portion 40 has a transport mechanism 49.

The first transport line 42 can convey the second analyte holding container 4 located at the position P1 into the positions P2, P3, P4, P5, P6, P7, and P8. After the second analyte holding container 4 is conveyed into the position P8, the container 4 is transported onto the third transport line 46 by the transport mechanism 49. The first transport line 42 moves the second analyte holding container 4 in a first direction A.

The positions P1 to P8 are on the first transport line 42. At the position P2, the analyte accommodated in the second analyte holding container 4 can be stirred by the stirring portion 84. At the position P4, the second analyte holding container 4 can be moved onto the second transport line 44a by the transport mechanism 49. At the position P5, the second analyte holding container 4 can be moved onto the second transport line 44b by the transport mechanism 49. At the position P6, the second analyte holding container 4 can be moved onto the second transport line 44c by the transport mechanism 49. At the position P7, the second analyte holding container 4 can be moved onto the second transport line 44d by the transport mechanism 49. The control portion 72 of the manipulation portion 70 determines whether the second analyte holding containers 4 located at the positions P4, P5, P6, and P7, respectively, should be moved onto the second transport lines 44a, 44b, 44c, and 44d, respectively.

The second transport line 44a conveys the second analyte holding container 4, which was transported through the first transport line 42, into the position P10 lying on the second transport line 44a. At this position P10, the first analyzing portion 60a picks up the analyte accommodated in the second analyte holding container 4. The second transport line 44a conveys the second analyte holding container 4, which has been moved from the position P4 on the first transport line 42, into the position P10. The second transport line 44a moves the second analyte holding container 4 in the first direction A. After the analyte is picked up by the first analyzing portion 60a, the second analyte holding container 4 located at the position P10 is transported into the position P11 by the second transport line 44a. After transported into the position P11, the second analyte holding container 4 is moved onto the first transport line 42 by the transport mechanism 49.

The second transport line 44b conveys the second analyte holding container 4, which has been conveyed by the first transport line 42, into the position P12 that lies on the second transport line 44b. At this position P12, the second analyzing portion 60b picks up the analyte held in the second analyte holding container 4. The second transport line 44b transports the second analyte holding container 4, which has been moved from the position P5 on the first transport line 42, into the position P12. The second transport line 44b moves the second analyte holding container 4 in the first direction A. After the analyte is picked up by the analyzing portion 60b, the second analyte holding container 4 located at the position P12 is conveyed into the position P13 by the second transport line 44b. Then, the container 4 is moved onto the first transport line 42 by the transport mechanism 49.

The second transport line 44c conveys the second analyte holding container 4, which has been conveyed by the first transport line 42, into a position P14 lying on the second transport line 44c. At this position P14, the third analyzing portion 60c picks up the analyte from inside the second analyte holding container 4. The second transport line 44c transports the second analyte holding container 4, which has been moved from the position P6 on the first transport line 42, into the position P14. The second transport line 44c moves the second analyte holding container 4 in the first direction A. After the analyte is picked up by the analyzing portion 60c, the second transport line 44c conveys the second analyte holding container 4 located at the position P14 into a position P15. Then, the second analyte holding container 4 is moved onto the first transport line 42 by the transport mechanism 49.

The second transport line 44d conveys the second analyte holding containers 4, which has been conveyed by the first transport line 42, into a position P16 lying on the second transport line 44d. At this position P16, the fourth analyzing portion 60d picks up the analyte received in the second analyte holding container 4. The second transport line 44d conveys the second analyte holding container 4, which has been shifted from the position P7 on the first transport line 42, into the position P16. The second transport line 44d moves the second analyte holding container 4 in the first direction A. After the analyte is picked up by the analyzing portion 60d, the second transport line 44d conveys the second analyte holding container 4 located at the position P16 into a position P17. Then, the container 4 is moved onto the first transport line 42 by the transport mechanism 49.

The third transport line 46 conveys the second analyte holding containers 4, which have been conveyed into at least one of the positions P10, P12, P14, and P16, back into the position P1. That is, the third transport line 46 is used to return the second analyte holding container 4 holding the analyte analyzed by the analyzing portions 60a, 60b, 60c, and 60d into the position P1 where an aliquot of an analyte is injected. The third transport line 46 moves the second analyte holding container 4 in a second direction B opposite to the first direction A. The third transport line 46 can convey the second holding container 4 located at a position P20 into positions P21, P22, P23, P24, P25, and P26.

The positions P20-P26 are on the third transport line 46. At the position P20, the second transport container 4 is moved onto the first transport line 42 by the transport mechanism 49. At the position P21, the identification information about the second analyte holding container 4 is read by the second identification portion 50. At the position P22, the second analyte holding container 4 can be moved onto the first transport line 42 or fourth transport line 48 by the transport mechanism 49. The control portion 72 of the manipulation portion 70 determines whether the second analyte holding container 4 should be moved onto the first transport line 42 or the fourth transport line 48 at the position P22. At the positions P23, P24, and P25, the second analyte holding container 4 can be cleaned by the cleaning portion 80. At the position P26, the second analyte holding container 4 can be moved into the position P1 on the first transport line 42 by the transport mechanism 49.

The fourth transport line 48 dilutes the analyte held in the second analyte holding container 4 and returns the analyte onto the first transport line 42. The fourth transport line 48 moves the second analyte holding container 4, which has been moved out of the third transport line 46, into the position P30 lying on the fourth transport line 48. At this position P30, the analyte in the second analyte holding container 4 is diluted by the analyte diluting portion 82. The fourth transport line 48 conveys the second analyte holding container 4 in the second direction B. The fourth transport line 48 can convey the second analyte holding container 4 located at the position P30 into a position P31. Then, the container 4 is moved into the position P1 by the transport mechanism 49.

For example, each of the transport lines 42, 44a, 44b, 44c, 44d, 46, and 48 is configured including a conveyor belt which is circulated through certain locations. When the second analyte holding container 4 is placed on the conveyor belts of the transport lines 42, 44a, 44b, 44c, 44d, 46, and 48, the container 4 can be moved by these transport lines.

The transport mechanism 49 can shift the second analyte holding container 4, which is being transported by any one of the transport lines 42, 44a, 44b, 44c, 44d, 46, and 48 of the second transport portion 40, onto other transport line 42, 44a, 44b, 44c, 44d, 46, or 48. For example, the transport mechanism 49 is configured including a gripping portion for gripping the second analyte holding container 4 and a moving mechanism for moving the gripping portion. The transport mechanism 49 grips, by means of its gripping portion, the second analyte holding container 4 conveyed by the transport lines 42, 44a, 44b, 44c, 44d, 46, and 48. The grip portion gripping the second analyte holding container 4 is moved by the moving mechanism. Consequently, the second analyte holding container 4 can be moved onto other transport lines 42, 44a, 44b, 44c, 44d, 46, or 48.

The transport path for the second analyte holding container 4 in the second transport portion 40 forms a closed loop. That is, the second analyte holding container 4 is conveyed out of the position P1 and back into the position P1. The transport path for the second analyte holding container 4 is a route through which the container 4 passes. In the second transport portion 40, the second analyte holding container 4 is conveyed by the first transport line 42, second transport lines 44a, 44b, 44c, 44d, and third transport line 46. Thus, the second analyte holding container 4 located at the position P1 can be conveyed back into the position P1.

FIG. 5 is a schematic perspective view of one second analyte holding container 4. In the illustrated example, the second analyte holding container 4 is placed on the first transport line 42. The second analyte holding container 4 is used to hold an aliquot of an analyte. The second analyte holding container 4 has a cell 4a for holding the aliquot of the analyte. Furthermore, the second analyte holding container 4 has a recording medium 4b which holds the identification information about the second analyte holding container 4 and which can be read by the second identification portion 50. The identification information about the second analyte holding container 4 is used to discriminate the subject second analyte holding container 4 from other second analyte holding containers 4. That is, identification data intrinsic to each individual second analyte holding container 4 is recorded on the recording medium 4b. In the illustrated example, the recording medium 4b is an RFID chip. The recording medium 4b may also be a barcode or an IC tag. Information can be written to the recording medium 4b. Also, information held in the recording medium 4b can be erased.

The second identification portion 50 obtains the identification information about the second analyte holding container 4. The second identification portion 50 can read the identification information about the second analyte holding container 4 from the recording medium 4b of the container 4. In the illustrated example, the second identification portion 50 obtains the identification information about the second analyte holding container 4 located at the position P21 on the third transport line 46. No restrictions are imposed on the position at which the identification information about the second analyte holding container 4 is read by the second identification portion 50, as long as the position is in the transport path for the second analyte holding container 4. The second identification portion 50 has an antenna 52, for example, as shown in FIG. 5. The second identification portion 50 can read information from the recording medium 4b and erase the information via the antenna 52. The second identification portion 50 is an IC tag reader, for example.

The analyzing portions 60a, 60b, 60c, and 60d pick up analytes held in the second analyte holding containers 4 and analyze the analytes picked up. The automated analyzer 100 has the first through fourth analyzing portions 60a, 60b, 60c, and 60d. That is, the automated analyzer 100 has the plural analyzing portions. No restrictions are placed on the number of the analyzing portions as long as there are at least two analyzing portions. In the automated analyzer 100, one analyzing portion 60a, 60b, 60c, or 60d may perform an analysis about plural items. Alternatively, one analyzing portion 60a, 60b, 60c, or 60d may perform an analysis about one item. Furthermore, the analyzing portions 60a, 60b, 60c, and 60d may perform analyses about different items or about the same item. The results of the analyses performed by the analyzing portions 60a, 60b, 60c, and 60d are sent to the control portion 72 of the manipulation portion 70.

As shown in FIG. 1, each of the analyzing portions 60a, 60b, 60c, and 60d is configured including a first aliquoter 62, a reaction cell turntable 64 on which plural reaction cells are arranged, at least one second aliquoter 66, a reagent container turntable 68 on which reagent containers are arranged, and an analyzing device 69. The first aliquoter 62 picks up an analyte from one second analyte holding container 4 and dispenses the analyte into a reaction cell. The second aliquoter 66 picks up a reagent from a reagent container and dispenses the reagent into the reaction cell. For example, before an analyte is aliquoted, the second aliquoter 66 dispenses the reagent into the reaction cell. The at least one second aliquoter 66 is plural in number, for example. The analyte and reagent within the reaction cell are stirred by a stirrer (not shown). The analyzing device 69 measures the analyte which has reacted with the reagent. The reaction cell turntable 64 moves each reaction cell into a position where the analyte is dispensed, into a position where the reagent is dispensed, and into a position where the analyte is measured. The analyzing portions 60a, 60b, 60c, and 60d can perform analyses of plural analytes in parallel.

The cleaning portion 80 cleans the second analyte holding container 4 passing through the third transport line 46. In the example shown in FIG. 2, the cleaning portion 80 cleans the second analyte holding containers 4 which are located at the positions P23, P24, and P25 lying on the third transport line 46 located between the positions P22 and P26.

The cleaning portion 80 is configured, for example, including a waste fluid aspirating pump 80a, a cleaning fluid pump 80b, and a drier 80c. The waste fluid aspirating pump 80a aspirates the analyte from inside the second analyte holding container 4 and discharges the analyte into a waste fluid tank (not shown). The cleaning fluid pimp 80b supplies a cleaning fluid into the second analyte holding container 4 to clean it. The drier 80c dries the second analyte holding container 4. In this way, the second analyte holding container 4 can be regenerated by the cleaning portion 80. That is, the original analyte in the second analyte holding container 4 is removed by cleaning the second analyte holding container 4 holding the analyte therein by the cleaning portion 80. Thus, a new aliquot of an analyte can be injected into the second analyte holding container 4.

The analyte diluting portion 82 can supply a diluting fluid for diluting the analyte into the second analyte holding container 4 passing through the fourth transport line 48. The analyte diluting portion 82 has the pipette 32, the drive mechanism 34, and a dilution container 82c, for example. In the analyte diluting portion 82, after the pipette 32 aspirates the diluting fluid from the dilution container 82c on the turntable, the pipette is moved by the moving mechanism 34. The fluid is dispensed into the second analyte holding container 4 located at the position P30 on the fourth transport line 48. Consequently, the analyte in the second analyte holding container 4 can be diluted again.

The stirring portion 84 stirs the analyte in the second analyte holding container 4 located in the position P3 on the first transport line 42. The stirring portion 84 has a stirring probe 84a for stirring an analyte and a probe actuating mechanism (not shown) for rotating or reciprocating the stirring probe 84a, for example. Furthermore, the stirring portion 84 may include a cleaning mechanism for cleaning the stirring probe 84a.

The sensors 90 are devices used for making a decision as to whether each second analyte holding container 4 is in position. For example, each sensor 90 is an optical sensor and can optically detect whether the second analyte holding container 4 is in position. In the illustrated example, the plural sensors 90 are provided so as to be capable of detecting the presence or absence of second analyte holding containers 4 at positions P1, P2, P6, P7, P8, P14, P16, P21, P30, and P31. No restrictions are imposed on the positions where the sensors 90 are mounted.

The manipulation portion 70 controls the various portions 10, 20, 30, 40, 50, 60a, 60b, 60c, 60d, 80, 82, 84, and 90 of the automated analyzer 100. The manipulation portion 70 can perform communications with a laboratory information system (US) used for clinical examinations or with a laboratory automation system (LAS), for example. The manipulation portion 70 can make an inquiry to the US or LAS to obtain information about analytes.

For example, the manipulation portion 70 is a programmed computer configured including a processing portion including the control portion 72, a display portion 74, an input portion 76, a storage portion 78, and an information storage medium 79.

The display portion 74 displays images generated by the processing portion. The functions of the display portion 74 can be realized by an LCD, a CRT, or the like. The display portion 74 can display the results of an analysis, for example.

The input portion 76 is used by a user to enter information about manipulations and to output the entered information about manipulations to the processing portion. The function of the input portion 76 can be implemented by a keyboard, a mouse, or other piece of hardware such as a touch-panel display.

The storage portion 78 acts as the working area of the processing portion. The function of the storage portion can be realized by a RAM or the like. The information storage medium 79 that is a medium capable of being read by a computer stores programs and data. The function of the medium 79 can be realized by optical disks (such as CD and DVD), magneto optical disk (MO), magnetic disk, hard disk, or memory (ROM). The processing portion performs various kinds of processing of the present embodiment based on a program stored in the information storage medium 79. Programs for operating the computer as various portions of the processing portion are stored in the information storage medium 79. Identification information about the first analyte holding containers 2, identification information about the second analyte holding containers 4, and information about analytes can be stored in at least one of the storage portion 78 and information storage medium 79. The information about analytes includes items of request necessary for measurements, types of analytes (such as blood serum and urine), and attributes of patients.

The processing portion performs various kinds of processing based on control data from the input portion 76 or on a computer program. The processing portion performs various kinds of processing while using the storage portion 78 as its working area. The functions of the processing portion can be realized by hardware (such as various processors (e.g., CPU and DSP) or ASIC (e.g., a gate array)), application programs, or an OS (such as a general-purpose OS). The processing portion has the control portion 72, which in turn performs processing for controlling the various portions 10, 20, 30, 40, 50, 60a, 60b, 60c, 60d, 80, 82, 84, and 90 of the automated analyzer 100. Furthermore, the control portion 72 can perform communications with the LIS or LAS.

The control portion 72 performs processing for associating the identification information about the first analyte holding containers 2 with the identification information about the second analyte holding containers 4. Furthermore, the control portion 72 determines which of the analyzing portions 60a, 60b, 60c, and 60d are used to grasp the positions of the second analyte holding containers 4 being conveyed by the second transport portion 40 based on the identification information about the second analyte holding containers 4 and to analyze analytes. That is, the control portion 72 determines a transport path for the second analyte holding containers 4.

In addition, the control portion 72 can obtain information about the analyte held in the first analyte holding container 2 from the LIS or LAS based on the identification information about the first analyte holding container 2.

### 1.2. Operation of the Automated Analyzer

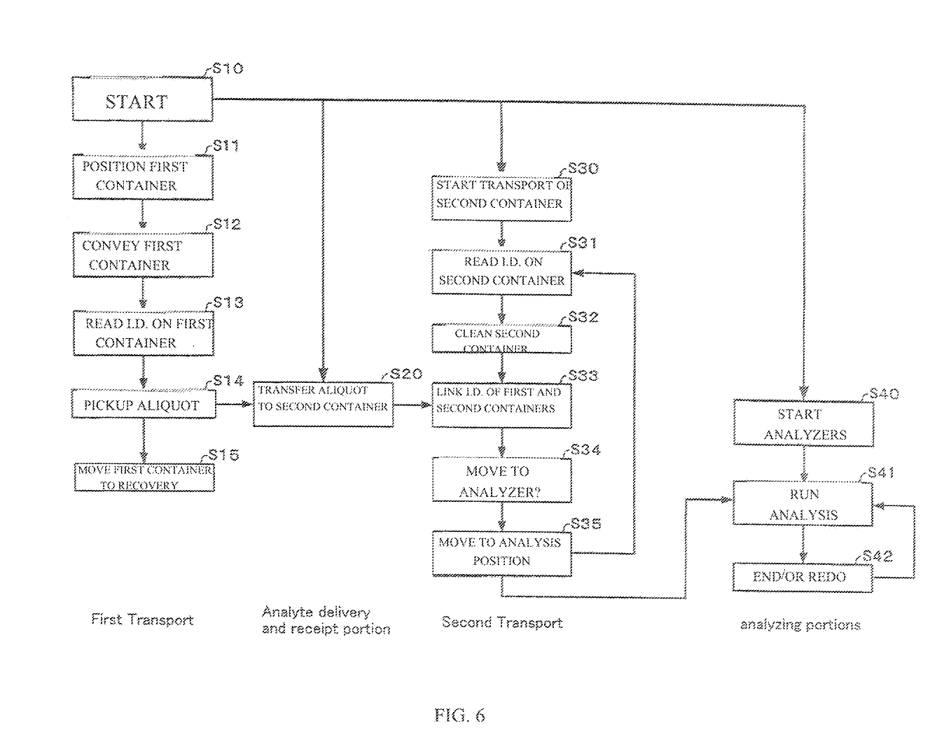

The operation of the automated analyzer 100 associated with the first embodiment is next described by referring to FIG. 6 that is a flowchart illustrating one example of a sequence of operations performed by the automated analyzer 100.

A Start instruction is given, for example, from the manipulation portion 70 of the control portion 72 to all of the first transport portion 10, analyte delivery and receipt portion 30, second transport portion 40, and analyzing portions 60a, 60b, 60c, and 60d (step S10).

Then, the user sets at least one first analyte holding container 2 holding a non-aliquoted analyte therein onto the analyte supply portion 14 while the container 2 is held in the rack 1 (step S11).

Then, the first transport portion 10 starts to convey the first analyte holding container 2 (step S12). The first transport portion 10 conveys the first analyte holding container 2 together with the rack 1 by the transport line 12. The first transport portion 10 transports the first analyte holding container 2 from the analyte supply portion 14 to the pick-up position P0 through the reading position of the first identification portion 20 by the transport line 12.

When the first analyte holding container 2 arrives at the reading position of the first identification portion 20, the first identification portion 20 reads the identification information (intrinsic identification data) about the first analyte holding container 2 (step S13). The first identification portion 20 reads the identification information about the first analyte holding container 2 from the recording medium 2b of the first analyte holding container 2. The first identification portion 20 sends the read identification information to the control portion 72 of the manipulation portion 70. The identification information about the first analyte holding container 2 is stored in the storage portion 78.

When the first analyte holding container 2 is conveyed into the pick-up position P0 where the analyte is aliquoted (step S14), the analyte delivery and receipt portion 30 passes the analyte into the second analyte holding container 4 from the first analyte holding container 2 (step S20). The analyte delivery and receipt portion 30 picks up the analyte held in the first analyte holding container 2 located at the pick-up position P0 and dispenses the analyte into the second analyte holding container 4 located at the position P1. The analyte dispensed into the second analyte holding container 4 is an aliquot of analyte.

When the analyte is picked up from the first analyte holding container 2 by the analyte delivery and receipt portion 30, the first transport portion 10 conveys the first analyte holding container 2 to the recovery portion 16 by the transport line 12 (step S15). The first transport portion 10, first identification portion 20, and analyte delivery and receipt portion 30 repeat the steps S13, S14, S20, and S15 according to the number of non-aliquoted analytes.

On the other hand, when a Start instruction is issued, the second transport portion 40 starts to convey the second analyte holding container 4 (step S30).

When the second analyte holding container 4 on the third transport line 46 is located at the position P21 (see FIG. 2), the second identification portion 50 reads the identification information (intrinsic identification data) about the second analyte holding container 4 (step S31). The second identification portion 50 reads the identification information about the second analyte holding container 4 from the recording medium 4b of the second analyte holding container 4. The second identification portion 50 sends the read identification information to the control portion 72 of the manipulation portion 70. The identification portion about the second analyte holding container 4 is stored in the storage portion 78. When reading of the identification information about the second analyte holding container 4 is complete, the second transport portion 40 conveys the second analyte holding container 4 into the positions P23, P24, and P25.

When the second analyte holding container 4 is located at the position P23, P24, or P25, the cleaning portion 80 cleans the second analyte holding container 4 (step S32). When the cleaning ends, the second transport portion 40 conveys the second analyte holding container 4 into the position P26 by the third transport line 46 and moves the container 4 into the position P1 on the first transport line 42 by the transport mechanism 49. When the second analyte holding container 4 is brought into the position P1, the analyte delivery and receipt portion 30 performs the step S20 to aliquot the analyte. At this time, the control portion 72 of the manipulation portion 70 links the identification information about the first analyte holding container 2 with the identification information about the second analyte holding container 4 (step S33). That is, the control portion 72 associates the identification information about the first analyte holding container 2 with the identification information about the second analyte holding container 4. The associated information is stored, for example, in the storage portion 78 of the manipulation portion 70.

When the analyte is aliquoted into the second analyte holding container 4 at the position P1, the second transport portion 40 conveys the second analyte holding container 4 located at the position P1 into the position P4 by the first transport line 42. Before the second analyte holding container 4 reaches the position P4, the stirring portion 84 may stir the analyte held in the second analyte holding container 4 at the position P2.

When the second holding container 4 is located at the position P4, if the control portion 72 determines that an analysis is performed by the first analyzing portion 60a, the second transport portion 40 shifts the second analyte holding container 4 onto the second transport line 44a by the transport mechanism 49. At this time, the control portion 72 sends information necessary for the analysis (such as items of measurement and analysis conditions) to the first analyzing portion 60a. No restrictions are placed on the timing at which the control portion 72 sends information to the first analyzing portion 60a as long as the first analyzing portion 60a can make preparations for performing an analysis based on the information.

When the control portion 72 has determined that no analysis is performed by the first analyzing portion 60a, the second transport portion 40 conveys the second analyte holding container 4 into the position P5 by the first transport line 42. The control portion 72 makes a decision as to whether the first analyzing portion 60a performs an analysis immediately prior to arrival at the position P4, i.e., makes a decision as to whether the analyte is drawn into the first analyzing portion 60a (step S34). No restriction is imposed on the timing at which the control portion 72 performs step S34. Preferably, this step is executed immediately before the container arrives at the position P4. The control portion 72 makes a decision as to whether the first analyzing portion 60a performs an analysis, based on the positional information (mapping information) about each second analyte holding container 4 being conveyed by the second transport portion 40. The processing performed by the control portion 72 at this time will be described later.

When the second analyte holding container 4 is sent to the second transport line 44a, the second transport portion 40 conveys the second analyte holding container 4 into the position P10 by the second transport line 44a (step S35).

The first analyzing portion 60a determines items of analysis, determines the order of analyses, and makes preparations for picking up reagents in response to information about the items of measurement and analysis conditions from the control portion 72 (step S40). When the second analyte holding container 4 arrives at the position P10, the first analyzing portion 60a picks up an analyte held in the second analyte holding container 4 (step S41). The first analyzing portion 60a then analyzes the analyte picked up (step S42).

When the analyte is taken from the second analyte holding container 4 by the first analyzing portion 60a, the second transport portion 40 conveys the second analyte holding container 4 from the position P10 into the position P11 by the second transport line 44a and returns the container onto the first transport line 42 by the transport mechanism 49. When the second analyte holding container 4 is returned onto the first transport line 42, the second transport portion 40 conveys the second analyte holding container 4 into the position P5 by the first transport line 42.

When the second analyte holding container 4 has arrived at the position P5, if the control portion 72 has determined that an analysis is performed by the second analyzing portion 60b, the second transport portion 40 shifts the second analyte holding container 4 onto the second transport line 44b by the transport mechanism 49. Subsequent operations are similar to operations performed in the case of the first analyzing portion 60a and so a description thereof is omitted. If the control portion 72 has determined that no analysis is performed by the second analyzing portion 60b, the second transport portion 40 conveys the second analyte holding container 4 into the position P6 by the first transport line 42.

When the second analyte holding container 4 is placed at the position P6, if the control portion 72 has determined that an analysis is performed by the third analyzing portion 60c, the second transport portion 40 shifts the second analyte holding container 4 onto the second transport line 44c by the transport mechanism 49. Subsequent operations are similar to the operations performed in the case of the first analyzing portion 60a and a description thereof is omitted. If the control portion 72 has determined that no analysis is performed by the third analyzing portion 60c, the second transport portion 40 conveys the second analyte holding container 4 into the position P7 by the first transport line 42.

When the second analyte holding container 4 is placed at the position P7, if the control portion 72 has determined that an analysis is performed by the fourth analyzing portion 60d, the second transport portion 40 shifts the second analyte holding container 4 onto the second transport line 44d by the transport mechanism 49. Subsequent operations are similar to the operations performed in the case of the first analyzing portion 60a and a description thereof is omitted. If the control portion 72 has determined that no analysis is performed by the fourth analyzing portion 60d, the second transport portion 40 conveys the second analyte holding container 4 into the position P8 by the first transport line 42.

When the second analyte holding container 4 is placed at the position P8, the second transport portion 40 shifts the second analyte holding container 4 onto the third transport line 46 by the transport mechanism 49. When the second analyte holding container 4 has been shifted onto the third transport line 46, the second transport portion 40 conveys the second analyte holding container 4 again into the position P21 by the third transport line 46. Then, the second identification portion 50 reads the identification information about the second analyte holding container 4 (step S31).

The control portion 72 of the manipulation portion 70 makes a decision as to whether the analyte needs to be reinspected, based on the results of the analyses performed by the analyzing portions 60a, 60b, 60c, and 60d. If the decision is that no reinspection is necessary, the automated analyzer 100 performs steps S31-S35. That is, a new analyte is put into the second analyte holding container 4 and analyzed. In this way, the second analyte holding container 4 is reused in the automated analyzer 100.

On the other hand, if the decision is that a reinspection is needed, the second transport portion 40 conveys the second analyte holding container 4 into the position P22 by the third transport line 46 and conveys the container into the position P3 on the first transport line 42 by the transport mechanism 49. The control portion 72 and the second transport portion 40 perform the steps S34 and S35. The analyzing portions 60a, 60b, 60c, and 60d perform steps S40, S41, and S42. If the second analyte holding container 4 receiving the reanalyzed analyte is again placed at the position P21, the control portion 72 can again make a decision as to whether a reinspection is again needed. Subsequent operations are similar to the operations performed in the foregoing case.

The automated analyzer 100 performs the above-described operations repeatedly to analyze plural analytes.

### 1.3. Flow of Information Through the Automated Analyzer

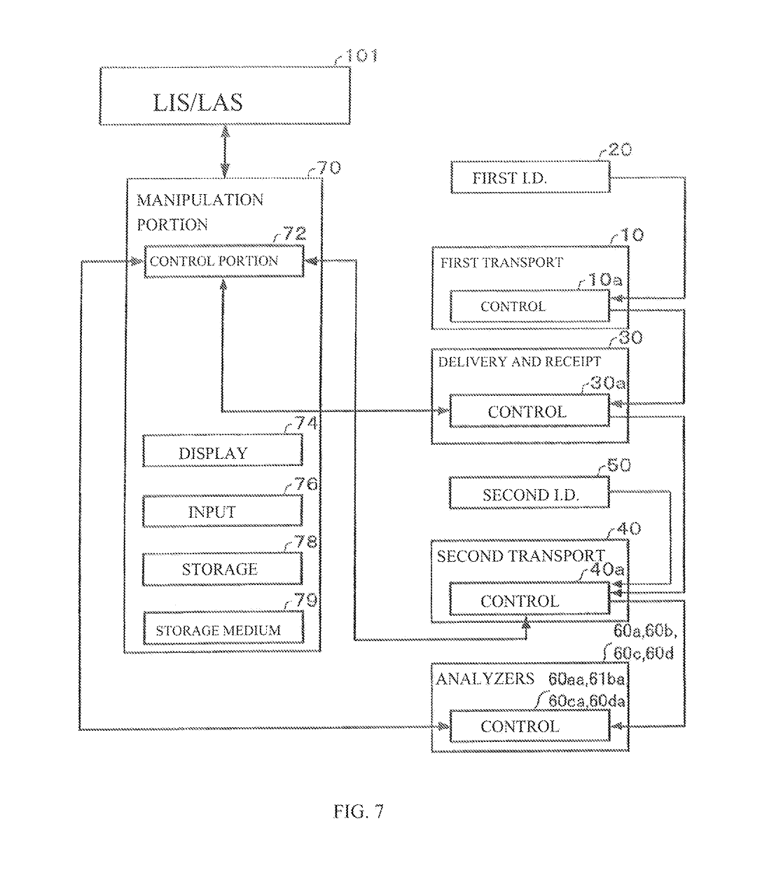

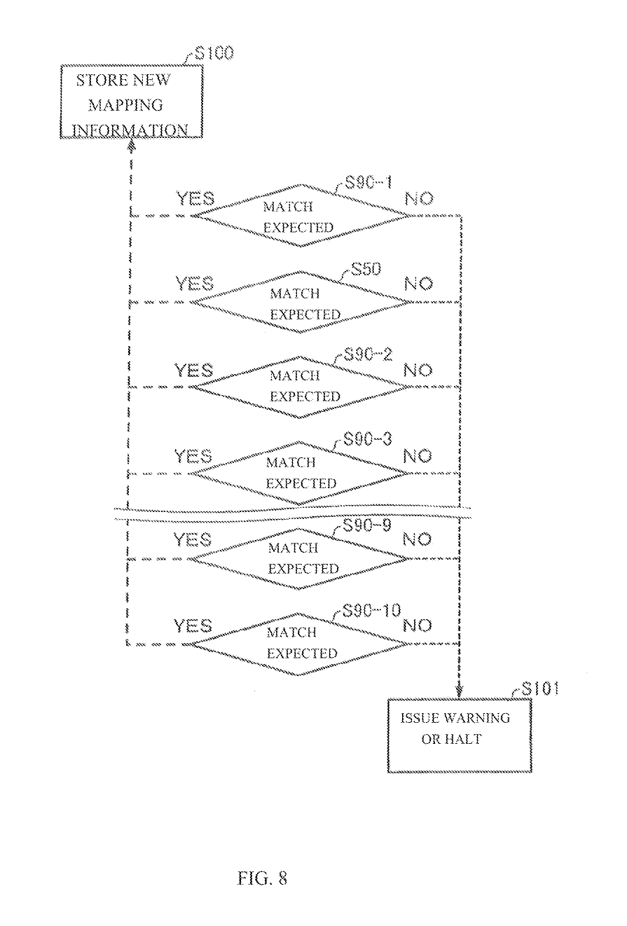

One example of flow of information through the automated analyzer 100 associated with the first embodiment is next described by referring to the flowchart of FIG. 7.

The intrinsic identification data (identification information) about the first analyte holding container 2 holding a non-aliquoted analyte therein is read by the first identification portion 20. The identification information about the first analyte holding container 2 is sent by the first identification portion 20 to the control portion 72 of the manipulation portion 70 via the control portion 10a of the first transport portion 10 and via the control portion 30a of the analyte delivery and receipt portion 30.

The control portion 72 obtains information about the analyte held in the first analyte holding container 2 based on the analyte information about the first analyte holding container 2. In particular, the control portion 72 of the manipulation portion 70 makes an inquiry to the LIS 101 or LAS 101 about the analyte information based on the identification information about the first analyte holding container 2. The analyte information is information about the analyte held in the first analyte holding container 2 identified with the identification information. The analyte information is sent to the manipulation portion 70 by the LIS or LAS 101. The analyte information is stored in the storage portion 78.

On the other hand, the intrinsic identification data (identification information) about the second analyte holding container 4 for holding an aliquot of analyte is read by the second identification portion 50. The identification information about the second analyte holding container 4 is sent to the control portion 72 of the manipulation portion 70 via the control portion 40a of the second transport portion 40 and stored in the storage portion 78.

The control portion 72 of the manipulation portion 70 sends information necessary for aliquoting of an analyte such as amount of analyte and dilution conditions to the analyte delivery and receipt portion 30, based on the analyte information stored in the storage portion 78. The analyte delivery and receipt portion 30 passes the analyte from the first analyte holding container 2 to the second analyte holding container 4 based on the information. At this time, the control portion 72 of the manipulation portion 70 associates the identification information about the first analyte holding container 2 holding a non-aliquoted analyte with the identification information about the second analyte holding container 4 holding an aliquot of analyte. That is, the control portion 72 of the manipulation portion 70 associates the identification information about the first analyte holding container 2 holding a non-aliquoted analyte with the identification information about the second analyte holding container 4 holding an aliquot of analyte. Since the control portion 72 has obtained the analyte information about the non-aliquoted analyte held in the first analyte holding container 2, it is possible to associate the analyte information about the non-aliquoted analyte held in the first analyte holding container 2 with the identification information about the second analyte holding container 4.

When the second analyte holding container 4 is placed at the position P4, the control portion 72 of the manipulation portion 70 senses the position of each second analyte holding container 4 conveyed by the second transport portion 40 based on the identification information about the second analyte holding container 4 and makes a decision as to whether an analysis is performed by the first analyzing portion 60a. Processing performed by the control portion 72 at this time will be described later. If the decision is that an analysis is performed by the first analyzing portion 60a, information necessary for the analysis such as items of measurement and analysis conditions is sent from the control portion 72 of the manipulation portion 70 to the control portion 60aa of the first analyzing portion 60a. The control portion 60aa of the first analyzing portion 60a operates based on this information.

When the second analyte holding container 4 is placed at the positions P5, P6, and P7, processing similar to the processing performed when the second analyte holding container 4 is placed at the position P4 is conducted by the analyzing portions 60b, 60c, and 60d (control portions 60ba, 60ca, and 60da) under control of the control portion 72. The results of the analyses obtained by the analyzing portions 60a, 60b, 60c, and 60d are sent to the control portion 72.

The second analyte holding container 4 holding an analyte already analyzed therein is conveyed into the position P21 by the third transport line 46. The identification information about the second analyte holding container 4 conveyed into the position P21 is read by the second identification portion 50. The control portion 72 of the manipulation portion 70 makes a decision as to whether the analyte is completed, based on the results of the analysis of the analyte held in the second analyte holding container 4. In other words, the control portion 72 of the manipulation portion 70 makes a decision as to whether a reanalysis is needed.

If the decision is that no reanalysis is needed, the identification information about the second analyte holding container 4 is stored in the storage portion 78 and associated with the identification information (analyte information) about the first analyte holding information 2 holding a newly aliquoted analyte. If the decision is that a reanalysis is needed, analyses are again performed by the analyzing portions 60a, 60b, 60c, and 60d, and a decision is made at the position P21 as to whether a reanalysis is needed.

### 1.4. Method of Determining Transport Path for Second Analyte Holding Containers

A method of determining a transport path for the second analyte holding containers 4 in the automated analyzer associated with the first embodiment is next described by referring to FIGS. 1-3 and 7.

The control portion 72 of the manipulation portion 70 senses (maps) the positions of the second analyte holding containers 4 conveyed by the second transport portion 40 and determines a transport path for the containers 4. That is, the control portion 72 of the manipulation portion 70 senses (maps) of the positions of the second analyte holding containers 4 conveyed by the second transport portion 40 via the control portion 40a and determines which of the analyzing portions 60a, 60b, 60c, and 60d is used to analyze analytes. The mapping is to sense the positions of the second analyte holding containers 4 conveyed by the second transport portion 40. The control portion 72 performs mapping based on the identification information about the second analyte holding containers 4 read by the second identification portion 50.

Specifically, the control portion 72 associates the identification information about the second analyte holding container 4 with the order in which the identification information was obtained (i.e., the order in which the second analyte holding container 4 passed through the position P21). Consequently, the control portion 72 can sense a position at which the second analyte holding container 4 will be placed next. Mapping can be done by repeating this processing operation about all the second analyte holding containers 4 conveyed by the second transport portion 40. The control portion 72 may perform the mapping by associating the identification information about the second analyte holding containers 4 with the time when the identification information was obtained (time when the container passed through the position P21).

The second transport portion 40 operates, for example, in given cycle times. That is, after a pause of a given time (e.g., 3 seconds), the second transport portion 40 moves the second analyte holding container 4 to the next position. Then, a pause of a given time (e.g., 3 seconds) is made and then the second analyte holding container 4 is moved into the next position. The second analyte holding container 4 is conveyed by repeating these operations. The second transport portion 40 can perform this sequence of operations at the same timing for all the second analyte holding containers 4 conveyed by the second transport portion 40. The various portions 10, 20, 30, 50, 60a, 60b, 60c, 60d, 80, 82, 84, and 90 of the automated analyzer 100 operate in conformity with these cycles. For example, when the second transport portion 40 is in a pause for a given time, the analyte delivery and receipt portion 30 aliquots an analyte into the second analyte holding containers 4 and the analyzing portions 60a, 60b, 60c, and 60d pick up analytes from the containers 4.

The control portion 72 senses where each second analyte holding container 4 is located every cycle, and senses, every cycle, the positions of the second analyte holding containers 4 conveyed by the second transport portion 40. That is, mapping is performed. Based on the mapping information obtained every cycle, the control portion 72 determines a position to which each second analyte holding container 4 will be moved in the next cycle. That is, the control portion 72 determines which of the analyzing portions 60a, 60b, 60c, and 60d is used to analyze the analyte held in the second analyte holding container 4, based on the mapping information obtained every cycle.

The transport path for the second analyte holding containers 4 in the second transport portion 40, i.e., the trajectory drawn by the moving second analyte holding containers 4, forms a closed loop. In particular, if one second analyte holding container 4 starts from a given position (such as the position P1 where an analyte is aliquoted), the container returns to the same position (P1). Therefore, once identification information about all the second analyte holding containers 4 conveyed by the second transport portion 40 is read in, the control portion 72 can keep track of the positions of all the second analyte holding containers 4 conveyed by the second transport portion 40. Accordingly, it is easy for the control portion 72 to sense the positions of the second analyte holding containers 4.

The information generated in this way about the positions of the second analyte holding containers 4 conveyed by the second transport portion 40, i.e., mapping information, is stored in the storage portion 78. The control portion 72 determines which of the analyzing portions 60a, 60b, 60c, and 60d is used to analyze the analyte held in the second analyte holding container 4, based on the mapping information. In particular, the control portion 72 senses the degrees of congestion of the analyzing portions 60a, 60b, 60c, and 60d from the mapping information and can determine which of the analyzing portions 60a-60d should be used to achieve the most efficient analysis, i.e., the processing is carried out most quickly. Consequently, the automated analyzer 100 can provide enhanced processing capabilities. As a result of the processing described so far, the transport path for the second analyte holding containers 4 is determined.

### 1.5. Method of Monitoring Second Analyte Holding Containers

A method of monitoring the second analyte holding containers 4 in the automated analyzer associated with the first embodiment is next described by referring to FIGS. 1, 2, 3, and 8.

As shown in FIGS. 1, 2, and 3, the plural sensors 90 are provided at the positions P1, P2, P6, P7, P8, P14, P16, P21, P30, and P31 in the second transport portion 40 to detect whether the second analyte holding containers 4 are present at these positions. The sensors 90 send information about the presence or absence of the second analyte holding containers 4 at these positions P1, P2, P6, P7, P8, P14, P16, P21, P30, and P31 to the control portion 72. The second identification portion 50 reads the identification information about the second analyte holding container 4 arriving at the position P21 and sends the read information to the control portion 72.

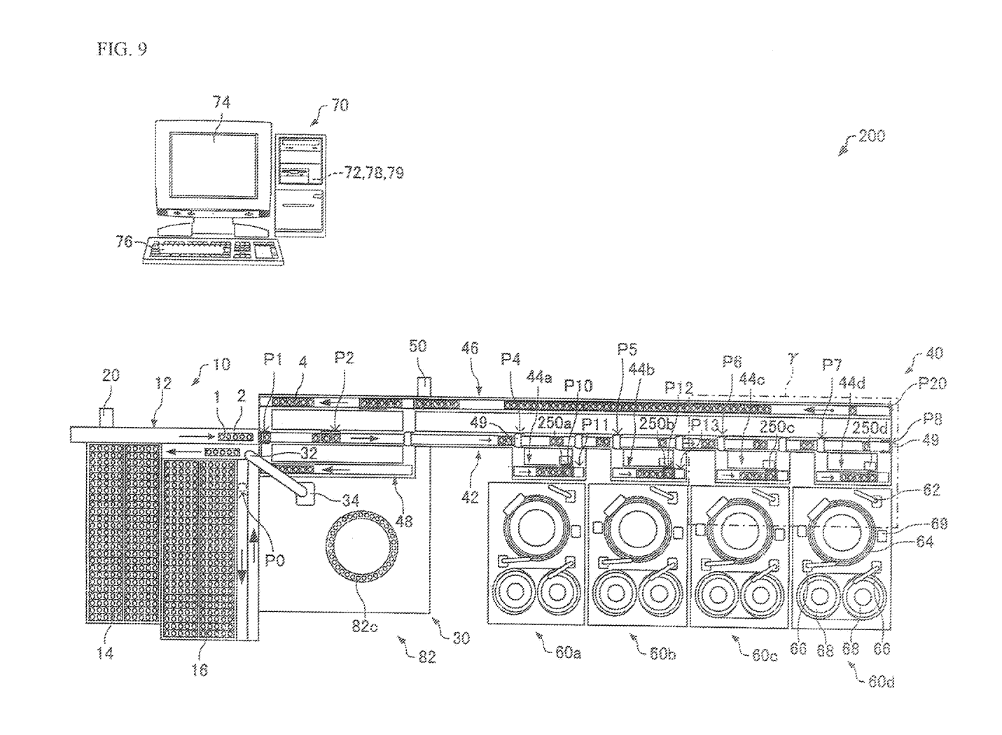

The control portion 72 makes a decision as to whether the mapping information stored in the storage portion 78 is consistent, based on the information from the sensors 90 about the presence or absence of the second analyte holding containers 4 at the positions P1, P2, P6, P7, P8, P14, P16, P21, P30, P31 and on the identification information about the second analyte holding containers 4 from the second identification portion 50. More specifically, the control portion 72 makes a decision based on the information about the presence or absence of the second analyte holding containers 4 as to whether the second analyte holding containers 4 are placed at the positions P1, P2, P6, P7, P8, P14, P16, P21, P30, and P31 as indicated by the mapping information (steps S90-1 to S90-10 of FIG. 8).

Furthermore, the control portion 72 makes a decision as to whether a given second analyte holding container 4 is located at the position P21 as indicated by the mapping information, based on the identification information about the second analyte holding containers 4 (S50). For example, where one second analyte holding container 4 not indicated by the mapping information is located at the position P21, there is the possibility that second analyte holding containers 4 (analytes) might become mixed up during transport. Accordingly, based on the identification information about the second analyte holding containers 4, the control portion 72 makes a decision as to whether a given second analyte holding container 4 is located at the position P21 as indicated by the mapping information, i.e., whether an analysis was performed by one of the analyzing portions 60a, 60b, 60c, and 60d determined by the control portion 72.

If all the decisions match the mapping information (YESes at steps S90-1 to S90-10 and S50), the control portion 72 updates the mapping information and stores new mapping information in the storage portion 78 (S100). If any one decision does not match the mapping information (NO at any one of steps S90-1 to S90-10 and S50), the control portion 72 performs processing for issuing a warning or stopping the operation of the various portions 10, 20, 30, 40, 50, 60a, 60b, 60c, 60d, 80, 82, 84, and 90 of the automated analyzer 100 (S101). The warning is displayed, for example, on the display portion 74.

The control portion 72 is monitoring the second analyte holding containers 4 in this way.

The automated analyzer 100 associated with the first embodiment has the following features.

In the automated analyzer 100, the control portion 72 performs a first processing step for associating the identification information about the first analyte holding containers 2 with the identification information about the second analyte holding containers 4 and a second processing step for sensing the positions of the second analyte holding containers 4 conveyed by the second transport portion 40 based on the identification information about the second analyte holding containers 4 and determines which of the analyzing portions 60a, 60b, 60c, and 60d is used to analyze analytes. In this way, in the automated analyzer 100, the control portion 72 senses the positions of the second analyte holding containers 4 conveyed by the second transport portion 40 and determines which of the analyzing portions 60a, 60b, 60c, and 60d is used to analyze analytes and so it is possible to determine which of the analyzing portions 60a, 60b, 60c, and 60d is used to analyze analytes according to the degrees of congestion of the analyzing portions 60a, 60b, 60c, and 60d. Accordingly, the automated analyzer 100 can provide enhanced processing capabilities.

For example, where the analyzing portions 60a, 60b, 60c, and 60d can analyze for the same items of analysis, it is necessary to perform analyses by the analyzing portions 60a, 60b, 60c, and 60d excluding congested ones, in order to enhance the processing capabilities of the automated analyzer. Hence, the circumstances of congestion can be precisely grasped because the control portion 72 can sense the positions of the second analyte holding containers 4 by performing mapping. This results in enhanced processing capabilities.

Furthermore, in the automated analyzer 100, the second transport portion 40 has the first transport line 42 for conveying the second analyte holding container 4 located at the first position P1, the plural second transport lines 44a, 44b, 44c, and 44d for conveying the second analyte holding containers 4 conveyed by the first transport line 42 to the positions P10, P12, P14, and P16, and the third transport line 46 for returning the second analyte holding containers 4 conveyed into the positions P10, P12, P14, and P16 to the first position P1. Therefore, in the automated analyzer 100, after the second analyte holding container 4 located at the position P1 where an analyte is aliquoted is analyzed by the analyzing portions 60a, 60b, 60c, and 60d, the container 4 can be returned to the position P1 by the analyte delivery and receipt portion 30. That is, the transport path for the second analyte holding containers 4 in the second transport portion 40 forms a closed loop. Therefore, the positions of the second analyte holding containers 4 conveyed by the second transport portion 40 can be sensed by at least one second identification portion 50. Hence, the automated analyzer is simple in structure but can provide enhanced processing capabilities.

In the second transport portion 40, the transport path for each second analyte holding container 4 differs according to different second analyte holding containers 4. Therefore, the second analyte holding containers may be out of order. In such a case, analytes can be prevented from becoming mixed up because the positions of the individual second analyte holding containers 4 are sensed based on the mapping information and the transport path is determined.

In the automated analyzer 100, the control portion 72 makes a decision as to whether analyses were performed by one of the analyzing portions 60a, 60b, 60c, and 60d selected by the control portion 72, based on the identification information about the second analyte holding containers 4. As a consequence, the analytes can be prevented from becoming mixed up.

Additionally, the automated analyzer 100 has the sensors 90 used to make a decision as to whether each second analyte holding container 4 has arrived at a given position. Hence, the analytes can be prevented from becoming mixed up.

The automated analyzer 100 includes the cleaning portion 80 for cleaning the second analyte holding container 4 passing through the third transport line 46. Accordingly, a new analyte can be received in the second analyte holding container 4. That is, the second analyte holding container 4 can be reused repetitively.

### 2. Second Embodiment

### 2.1. Configuration of the Automated Analyzer

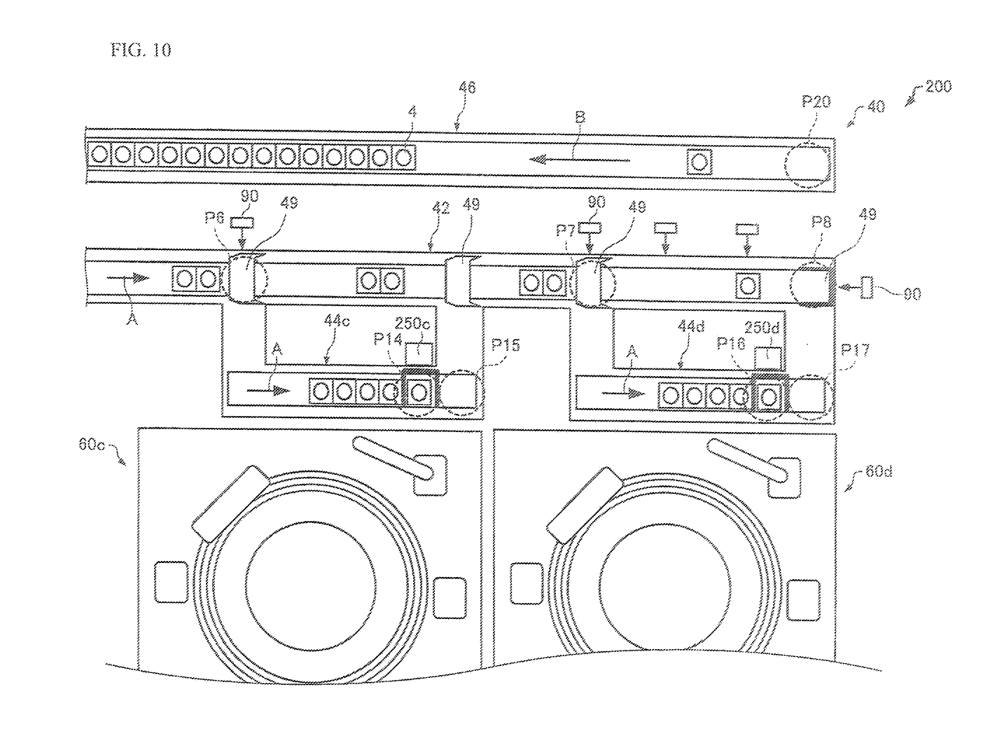

The configuration of an automated analyzer associated with a second embodiment of the present invention is next described by referring to some figures. FIG. 9 is a schematic plan view of the automated analyzer, 200, showing its configuration. FIG. 10 is a schematic plan view of a part of a second transport portion 40 of the automated analyzer 200. FIG. 10 schematically shows a region γ of FIG. 9.

Those constituent components of the automated analyzer 200 associated with the second embodiment which are similar in function with their counterparts of the above-described automated analyzer 100 associated with the first embodiment are indicated by the same reference numerals as in the above-cited figures and a detailed description thereof is omitted.

The automated analyzer 200 can include one third identification portion 250a for obtaining identification information about the second analyte holding container 4 located at the position P10, another third identification portion 250b for obtaining identification information about the second analyte holding container 4 located at the position P12, a further third identification portion 250c for obtaining the identification information about the second analyte holding container 4 located at the position P14, and a still other third identification portion 250d for obtaining the identification information about the second analyte holding container 4 located at the position P16.

The third identification portions 250a, 250b, 250c, and 250d obtain the identification information about the second analyte holding containers 4. The third identification portions 250a-250d can read the identification information about the second analyte holding containers 4 from the recording media 4b of the containers 4.

### 2.2. Operation of the Automated Analyzer

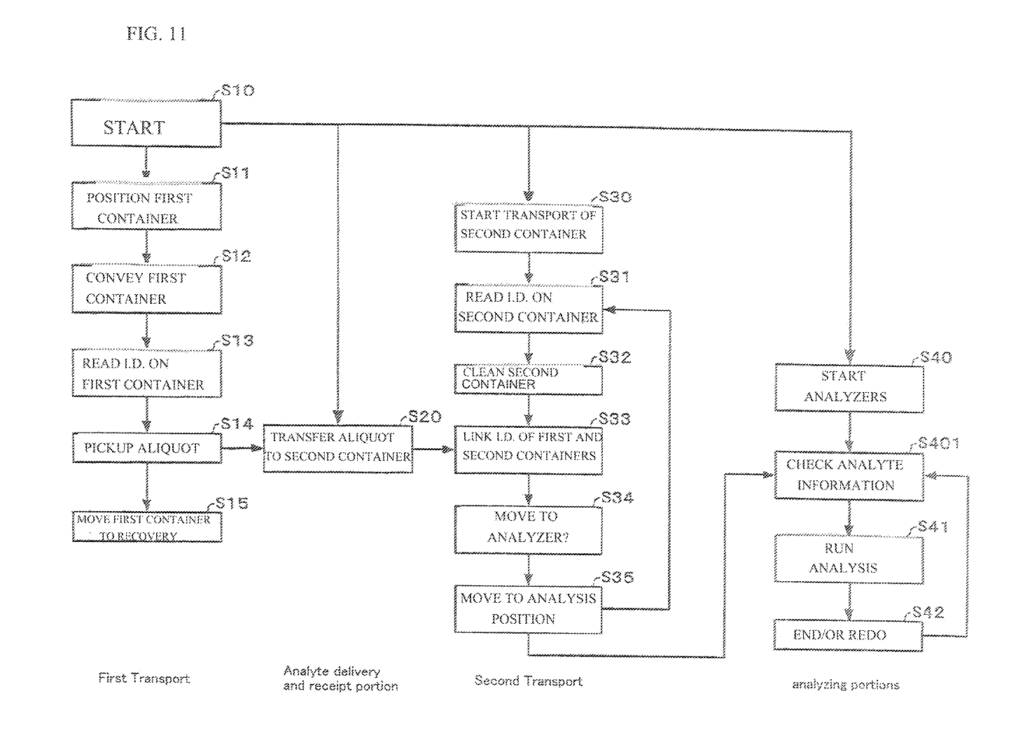

The operation of the automated analyzer 200 associated with the second embodiment is next described by referring to the flowchart of FIG. 11 that illustrates one example of a sequence of operations performed by the automated analyzer 200. In the following, only the differences with the above-described automated analyzer 100 associated with the first embodiment are described; a detailed description of similar points is omitted.

In the automated analyzer 200, if the second analyte holding container 4 is conveyed into the position P10 (step S35), the third identification portion 250a reads the identification information about the second analyte holding container 4 located at the position P10. The third identification portion 250a sends the identification information about the second analyte holding container 4 to the control portion 72 of the manipulation portion 70. The control portion 72 makes a decision as to whether the analyte in the second analyte holding container 4 is correct for checking purposes, based on the identification information about the second analyte holding container 4 and the mapping information (step S401). That is, the control portion 72 makes a decision as to whether the given second analyte holding container 4 is located at the position P10 as indicated by the mapping information. If the decision is that the analyte in the second analyte holding container 4 is correct, the first analyzing portion 60a picks up the analyte (step S41).

If the decision is that the analyte in the second analyte holding container 4 is not correct, the first analyzing portion 60a stops from picking up the analyte. The manipulation portion 70 then issues a warning.

When the second analyte holding container 4 is conveyed into the position P12, the third identification portion 250b reads the identification information about the second analyte holding container 4 located at the position P12 and sends the information to the control portion 72 of the manipulation portion 70. Subsequent processing performed by the control portion 72 is similar to the processing performed in the case of the third identification portion 250a.

When the second analyte holding container 4 is conveyed into the position P14, the third identification portion 250c reads the identification information about the second analyte holding container 4 located at the position P14 and sends the information to the control portion 72 of the manipulation portion 70. Subsequent processing performed by the control portion 72 is similar to the processing performed in the case of the third identification portion 250a.

When the second analyte holding container 4 is conveyed into the position P16, the third identification portion 250d reads the identification information about the second analyte holding container 4 located at the position P16 and sends the information to the control portion 72 of the manipulation portion 70. Subsequent processing performed by the control portion 72 is similar to the processing performed in the case of the third identification portion 250a.

The automated analyzer 200 associated with the second embodiment is configured including the third identification portions 250a, 250b, 250c, and 250d for obtaining identification information about the second analyte holding containers 4 located at the positions P10, P12, P14, and P16 where the analyzing portions 60a, 60b, 60c, and 60d pick up analytes. That is, the position where an analyte is picked up is the same as the position where the analyte is checked. Accordingly, it is possible to prevent analytes from becoming mixed up with greater certainty.

In the automated analyzer 200, the control portion 72 of the manipulation portion 70 determines which of the analyzing portions 60a, 60b, 60c, and 60d is used to perform an analysis, based on the identification information from the second identification portion 50. Therefore, each of the third identification portions 250a, 250b, 250c, and 250d only needs to check whether the analyte is correct. Consequently, the analyzing portions 60a, 60b, 60c, and 60d can push forward preparations for analysis before analytes are picked up. Furthermore, the position where an analyte is taken can be made equal to the position where the analyte is checked. Accordingly, the automated analyzer 200 can provide enhanced processing capabilities while reliably preventing analytes from becoming mixed up.

The present invention embraces configurations substantially identical (e.g., in function, method, and results or in purpose and advantageous effects) with the configurations described in the embodiments of the invention. Furthermore, the invention embraces configurations described in the embodiments and including portions which have non-essential portions replaced. In addition, the invention embraces configurations which produce the same advantageous effects as those produced by the configurations described in the embodiments or which can achieve the same objects as the configurations described in the embodiments. Further, the invention embraces configurations which are similar to the configurations described in the embodiments except that well-known techniques have been added.

Having thus described my invention with the detail and particularity required by the Patent Laws, what is desired protected by Letters Patent is set forth in the following claims.

The invention claimed is:

1. An automated analyzer comprising:
a first transport portion for conveying a first analyte holding container that holds an analyte therein;
a first identification portion for obtaining identification information about the first analyte holding container;
an analyte delivery and receipt portion for picking up the analyte from the first analyte holding container and transferring the analyte to a plurality of second analyte holding containers;
a second transport portion for conveying the second analyte holding containers;
a second identification portion for obtaining identification information about the second analyte holding containers;
a plurality of analyzing portions for picking up the analytes from the second analyte holding containers and analyzing the analytes picked up; and
a control portion for controlling the second transport portion,
wherein said analyte delivery and receipt portion transfers the analytes into the second analyte holding containers at a first position;
wherein said second transport portion has a first transport line for conveying the second analyte holding container located at the first position, a plurality of second transfer lines for conveying the second analyte holding containers conveyed by the first transport line into a pick-up position where the analyzing portions pick up the analytes, and a third transport line for returning the second analyte holding containers placed in the pick-up position into the first position; and
wherein said control portion performs a first processing step for associating identification information about the first analyte holding container with the identification information about the second analyte holding containers and a second processing step for sensing positions of the second analyte holding containers conveyed by the second transport portion based on the identification information about the second analyte holding containers and determining which of the analyzing portions is used to analyze the analytes.

2. The automated analyzer as set forth in claim 1, wherein said control portion obtains information about the analyte held in the first analyte holding container, based on the identification information about the first analyte holding container.

3. The automated analyzer as set forth in claim 1, wherein each of said analyzing portions includes a third identification portion for obtaining identification information about said second analyte holding container located at said pick-up position.

4. The automated analyzer as set forth in claim 1, wherein a transport path for the second analyte holding containers in said second transport portion constitutes a closed loop.

5. The automated analyzer as set forth in claim 1, wherein said control portion makes a decision, based on the identification information about the second analyte holding containers, as to whether each of the analytes has been analyzed by the analyzing portion determined by said second processing step.

6. The automated analyzer as set forth in claim 1, further comprising sensors used to make a decision as to whether each of said second analyte holding containers is in position.

7. The automated analyzer as set forth in claim 1, further comprising a cleaning portion for cleaning said second analyte holding containers passing through said third transport line.
